(19) United States
(12) Patent Application Publication
(10) Pub. No.: US 2012/0128173 A1
(43) Pub. Date: May 24, 2012

(54) RADIO SYSTEM INCLUDING TERRESTRIAL AND INTERNET RADIO

(75) Inventors: J. William Whikehart, Milford, MI (US); Shadi Mere, Canton, MI (US); Theodore Charles Wingrove, Canton, MI (US)

(73) Assignee: VISTEON GLOBAL TECHNOLOGIES, INC., Van Buren Twp., MI (US)

(21) Appl. No.: 13/356,943

(22) Filed: Jan. 24, 2012

Related U.S. Application Data
(63) Continuation-in-part of application No. 12/953,897, filed on Nov. 24, 2010.

(51) Int. Cl. H04B 3/00

(52) U.S. Cl. 381/77

(57) ABSTRACT

A radio system includes a radio tuner for receiving a terrestrial radio signal, a communication device for receiving an internet data, a user interface in signal communication with at least the radio tuner to provide a selective control of at least the radio tuner, and a processor in signal communication with the radio tuner, the communication device, and the user interface, wherein the processor receives a user preference data from at least one of the communication device and the user interface, analyzes the user preference data based on an instruction set, and selectively transmits an audio output to a user based upon the user preference data, wherein a source of the audio output is one of the terrestrial radio signal and the internet data.

### CROSS-REFERENCE TO RELATED APPLICATION

This application is a continuation-in-part of and claims the benefit of U.S. application Ser. No. 12/953,897 filed on Nov. 24, 2010.

### FIELD OF THE INVENTION

The present invention relates generally to a radio system. In particular, the invention is directed to an adaptive radio system having multiple signal sources.

### BACKGROUND OF THE INVENTION

Currently, there are generally four types of radio platforms available in a vehicle environment: terrestrial AM/FM radio, terrestrial HD radio, satellite radio, and Internet radio.

Internet radio has the advantage of allowing a user build a profile of preferred stations. For example, programs such as the Music Genome Project from the Pandora Media company automatically select a similar genre of music for playback based on a preferred band identified by a user.

However, a shortcoming of Internet radio in a moving vehicle is the continuing connectivity with the internet (i.e. sometimes the Internet radio connection is lost due to poor connectivity).

Current terrestrial radio systems do not automatically create a profile of preferred stations. Although a user may preset certain regional terrestrial radio channels, the user is forced to search for desirable stations when travelling in a region beyond the broadcast range of preset channels.

It would be desirable to develop an adaptive radio system having multiple signal sources, wherein the radio system selectively transmits an audio output from one of the signal sources to a user based upon a preference of the user.

### SUMMARY OF THE INVENTION

Concordant and consistent with the present invention, an adaptive radio system having multiple signal sources, wherein the radio system selectively transmits an audio output from one of the signal sources to a user based upon a preference of the user, has surprisingly been discovered.

One method comprises the steps of: providing at least two communication devices for receiving an audio output; providing user preference data including defining a first user and at least a second user forming a group of users; connecting the group of users for communicating between the at least two communication devices; and selectively sharing information from at least one user of the group of users to at least the second user of the group.

Another method comprises the steps of: providing at least two communication devices for receiving an audio output; providing user preference data including defining at least two users forming a group of users, wherein the group of users forms a closed group; connecting the closed group for communicating between the at least two communication devices; and selectively transmitting an output from at least one user to the closed group by the connection.

Still another method comprises the steps of: providing at least two communication devices for receiving an audio output; providing user preference data including defining a first user and at least a second user forming a group of users, wherein the group of users forms a first closed group; connecting the first closed group of users for communicating between the at least two communication devices; selectively transmitting an output from at least one user of the first closed group to at least the second user of the first closed group; providing a second closed group; providing the second closed group at least one communication device for receiving an audio output; and the first closed group providing access to the transmitted audio output of the first closed group to the second closed group.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a perspective view of an adaptive radio system integrated into a vehicle according to an embodiment of the present invention;

FIG. 2 is a schematic block diagram of the radio system of FIG. 1; and

FIG. 3 is a schematic flow diagram of a method for adapting an audio output using multiple signal sources.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

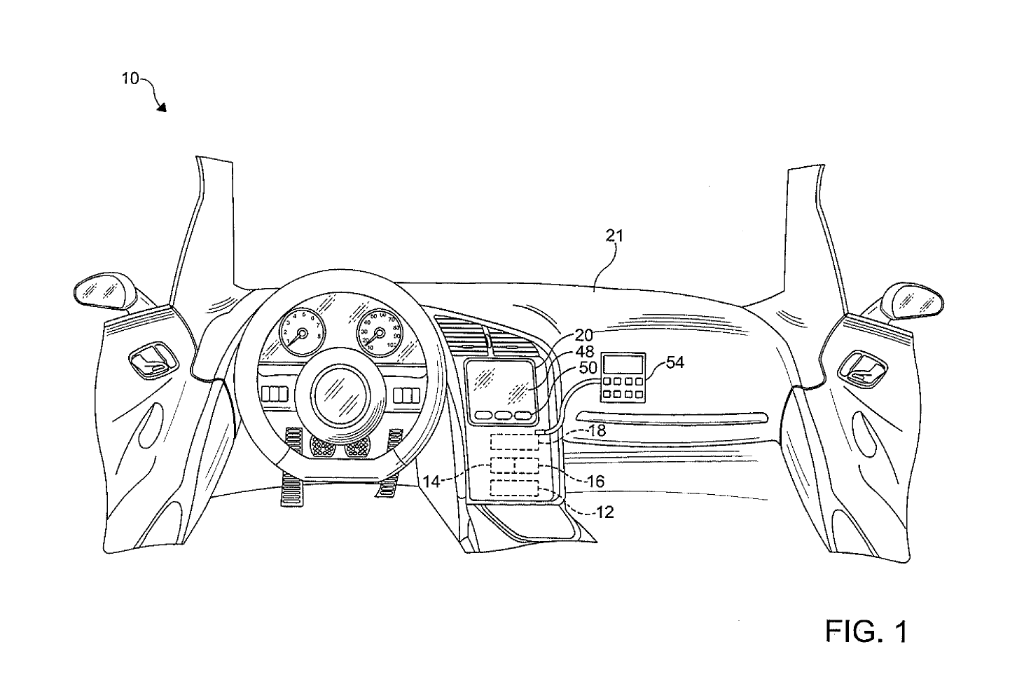

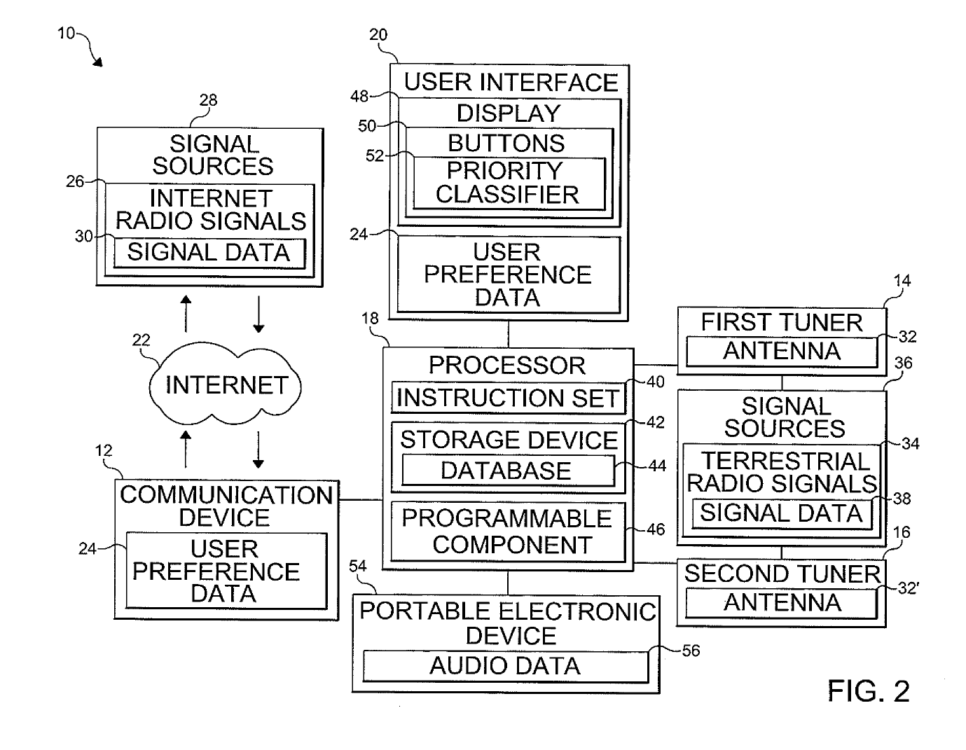

FIGS. 1-2 illustrate an adaptive radio system 10 according to an embodiment of the present invention. As shown, the radio system 10 includes a communication device 12, a first tuner 14, a second tuner 16, a processor 18, and a user interface 20. The radio system 10 can include any number of components, as desired. As a non-limiting example, the radio system 10 is disposed in a vehicle 21. However, the radio system 10 can be integrated in any user environment.

The communication device 12 can be any device, port, or system capable of providing connectivity to the Internet 22. As a non-limiting example, the communication device 12 is a personal electronic device such as a mobile phone, a smart phone, a Wi-Fi™ enabled device, and the like. As a further non-limiting example the communication device 12 is an in-vehicle Internet device that is integrated with the vehicle 21, as understood by one skilled in the art.

In certain embodiments, the communication device 12 includes a user preference data 24 representing a plurality of user preferences relating to an audio output (e.g. a genre of music, a news program, a particular musical band, a particular radio channel/station, etc.). Where the user preference data 24 is not stored locally on the communication device 12, the communication device 12 can download the user preference data 24 from a pre-determined location via the Internet 22. As a non-limiting example, the user preference data 24 can be organized as a user profile, wherein any user can create a user profile representing preferences particular to the user. As a further non-limiting example, a secondary software (not shown) can be used to generate a user profile including the user preference data 24 such as the Music Genome Project™ software by Pandora Media, Inc.

In certain embodiments, the communication device 12 is in communication with the Internet 22 to locate and receive a plurality of internet radio signals 26 (i.e. internet data), wherein each of the Internet radio signals 26 is hosted/transmitted by one of a plurality of signal sources 28 (e.g. internet radio stations/channels/data sources). As a non-limiting example, each of the internet radio signals 26 received by the communication device 12 includes an internet signal data 30 representing an audio output (e.g. music, talk radio, weather report, etc.). As a further non-limiting example, the internet signal data 30 includes information relating to the signal source 28 of each of the internet radio signals 26, wherein the information includes identification features (i.e. an audio attribute) such as a genre or type of audio output typically broadcast by the associated internet radio channel, a song or artist typically featured on the associated internet radio channel, and the like, for example. It is understood that the internet signal data 30 can include any information to identify and distinguish one of the signal sources 28 from another of the signal sources 28 based upon a typical audio output provided by the associated signal source 28. It is further understood that the Internet radio signal 26 can be any data retrieved or transmitted via the Internet 22 or similar communication network now know or later developed.

The first tuner 14 is configured to “tune” to a pre-determined narrow range of frequencies from the total spectrum of broadcast signals and ambient radio waves, as appreciated by one skilled in the art. In certain embodiments, the first tuner 14 is coupled to an antenna 32 to receive a broadcast radio frequency (RF) signal such as a terrestrial radio signal 34 (e.g. HD AM/FM radio or regular AM/FM broadcast) transmitted at a pre-determined frequency by one of a plurality of signal sources 36 (e.g. terrestrial radio frequency channels, radio stations). The antenna 32 may be any device for receiving broadcast signals having a pre-determined range of frequencies.

The terrestrial radio signal 34 includes a terrestrial signal data 38 representing an audio output (e.g. music, talk radio, weather report, etc.). As a further non-limiting example, the terrestrial signal data 38 includes information relating to the signal source 36 of the terrestrial radio signal 34, wherein the information includes identification features (i.e. an audio attribute) such as a genre or type of audio output typically broadcast by the associated terrestrial radio channel, a song or artist typically featured on the associated terrestrial radio channel (i.e. signal source 36), and the like, for example. It is understood that the terrestrial signal data 38 can include any information to identify and distinguish one of the signal sources 36 from another of the signal sources 36 based upon a typical audio output provided by the associated signal source 36.

The second tuner 16 is configured to “tune” to a pre-determined narrow range of frequencies from the total spectrum of broadcast signals and ambient radio waves, as appreciated by one skilled in the art. In certain embodiments, the second tuner 16 is coupled to an antenna 32′ to receive a broadcast radio frequency (RF) signal such as the terrestrial radio signals 34 transmitted at a pre-determined frequency by the signal sources 36. The antenna 32′ may be any device for receiving broadcast signals (e.g. HD AM/FM radio or regular AM/FM broadcast) having a pre-determined range of frequencies.

The processor 18 may be any device or system adapted to receive an input signal, analyze and evaluate the input signal, and control an audio output transmitted to the user based on the analysis of the input signal. In certain embodiments, the processor 18 is a micro-computer. In the embodiment shown, the processor 18 receives the input signal from at least one of the communication device 12 and the user interface 20. As a non-limiting example, the input signal represents at least the user preference data 24. It is understood that the processor 18 may be in communication with and may provide control of other devices (e.g. global positioning system), systems and components.

As shown, the processor 18 analyzes and evaluates the data signal based upon an instruction set 40. The instruction set 40, which may be embodied within any computer readable medium, includes processor executable instructions for configuring the processor 18 to perform a variety of tasks. It is understood that the processor 18 may execute a variety of functions such as controlling the functions of the communication device 12, the first tuner 14, the second tuner 16, and the user interface 20, for example. As a non-limiting example, the instruction set 40 is an algorithm or software adapted to determine the habitual actions and preferences of the user based upon the information received by the processor 18 (e.g. via the user interface 20). Specifically, the processor 18 can generate the user preference data 24 based upon a user-provided input via the user interface 20. As a further example, the instruction set 40 includes an algorithm or software for comparing the user preference data 24 to the signal data 30, 38 of at least one of the internet radio signals 26 and the terrestrial radio signals 34. Accordingly, the instruction set 40 includes processor executable instructions to determine which of the signal data 30, 38 substantially matches the user preference data 24. It is understood that the processor 18 can designate a particular one of the signal sources 28, 36 of at least one of the internet radio signals 26 and the terrestrial radio signals 34 as a “preferred” source/channel or a “matched” source/channel. It is further understood that any number of the signal sources 28, 36 of the internet radio signals 26 and the terrestrial radio signals 34 can be designated as a “preferred” source/channel.

In certain embodiments, the processor 18 includes a storage device 42. The storage device 42 may be a single storage device or may be multiple storage devices. Furthermore, the storage device 42 may be a solid state storage system, a magnetic storage system, an optical storage system, or any other suitable storage system or device. It is understood that the storage device 42 is adapted to store the instruction set 40. Other data and information may be stored and cataloged in the storage device 42 such as the data collected by the user interface 20.

In certain embodiments, the storage device 42 includes a database 44 of the signal sources 28, 36 of the internet radio signals 26 and the terrestrial radio signals 34. As a non-limiting example, the database 44 includes information relating to the signal sources 28, 36 such as a genre or type of audio output typically broadcast by the associated terrestrial radio channel, a song or artist typically featured on the associated terrestrial radio channel, and the like, for example. As a further non-limiting example, the database 44 is updated by a station server (not shown) including a catalog of the signal sources 28, 36, as appreciated by one skilled in the art.

In certain embodiments, the storage device 42 includes a plurality of user profiles (not shown), each of the user profiles including the user preference data 24 associated with a particular user. Accordingly, any one of the user profiles can be selected by the processor 18 to extract the user preference data 24 for analysis and comparison.

In certain embodiments, each time the user interacts with the user interface 20, an entry is created in the storage device 42. The entry includes a plurality of data fields populated with the information received by the user, wherein the entry is analyzed by the processor 18 to define the user preference data 24 for a particular user. For example, every weekday morning between six o'clock and seven o'clock the user tunes the first tuner 14 to a particular preset one of the signal sources 36 (e.g. a favorite morning show). Accordingly, the entry and the user preference data 24 is updated to include the information relating to the particular preset one of the signal sources 36 and the signal data 38 received there from.

The processor 18 may further include a programmable component 46. It is understood that the programmable component 46 may be in communication with any other component of the radio system 10 such as the communication device 12, the first tuner 14, the second tuner 16, and the user interface 20, for example. In certain embodiments, the programmable component 46 is adapted to manage and control processing functions of the processor 18. Specifically, the programmable component 46 is adapted to modify the instruction set and control the analysis of the input signals and information received by the processor 18. It is understood that the programmable component 46 may be adapted to manage and control at least one of the communication device 12, the first tuner 14, the second tuner 16, and the user interface 20. It is further understood that the programmable component 46 may be adapted to store data and information on the storage device 42, and retrieve data and information from the storage device 32.

The user interface 20 is in signal communication with at least one of the communication device 12, the first tuner 14, and the second tuner 16 to provide selective control over the at least one of the communication device 12, the first tuner 14, and the second tuner 16. As shown, the user interface 20 is in indirect signal communication with at least one of the communication device 12, the first tuner 14, and the second tuner 16. However, it is understood that the user interface 20 can be in direct signal communication with any component of the system.

The user interface 20 typically includes a display 48 for presenting a visible output to the user. In the embodiment shown, the display 48 is a touch sensitive display (i.e. touch screen) having a plurality of user-engageable buttons 50 presented thereon. In certain embodiments, each of the buttons 50 is associated with an executable function.

As a non-limiting example, the buttons 50 represent a plurality of priority classifiers 52 such as a signal strength, a genre of music, a navigation path, a mood of the user, etc. Accordingly, where a user engages one of the buttons 50 representing a particular priority classifier 52, the processor 18 organizes a list of the “preferred” sources/channels based upon the selected one of the priority classifiers 52. As a non-limiting example, where the priority classifier 52 representing a signal strength is selected by the user, the processor 18 arranges the list of preferred sources based upon a hierarchy of strongest signal strength to weakest signal strength. It is understood that any priority classifier can be used.

As a further non-limiting example, at least one of the buttons 50 represents a “like” feedback and at least one of the buttons 50 represents a “dislike” feedback. Accordingly, when an audio output is transmitted to the user, the user can provide a real-time feedback regarding the audio output. Specifically, where the user engages one of the buttons 50 representing the “like” feedback, the signal data associated with the audio output currently being transmitted to the user is used to update the user preference data 24. It is understood that various techniques for updating the user preference data 24 can be used such as a drag and drop technique using the display 48.

In certain embodiments, a portable electronic device 54 (e.g. digital music player, digital storage device, etc.) is in communication with the processor 18 by a wired (e.g. universal serial bus) or wireless connection. Accordingly, the processor 18 can retrieve an audio data 56 from the portable electronic device for transmission to the user as the audio output. It is understood that any amount of audio data (e.g. two songs) can be retrieved from the portable electronic device 54. It is further understood that the audio data 56 can be retrieved from the portable electronic device 54 and cached in the storage device 42 for subsequent transmission.

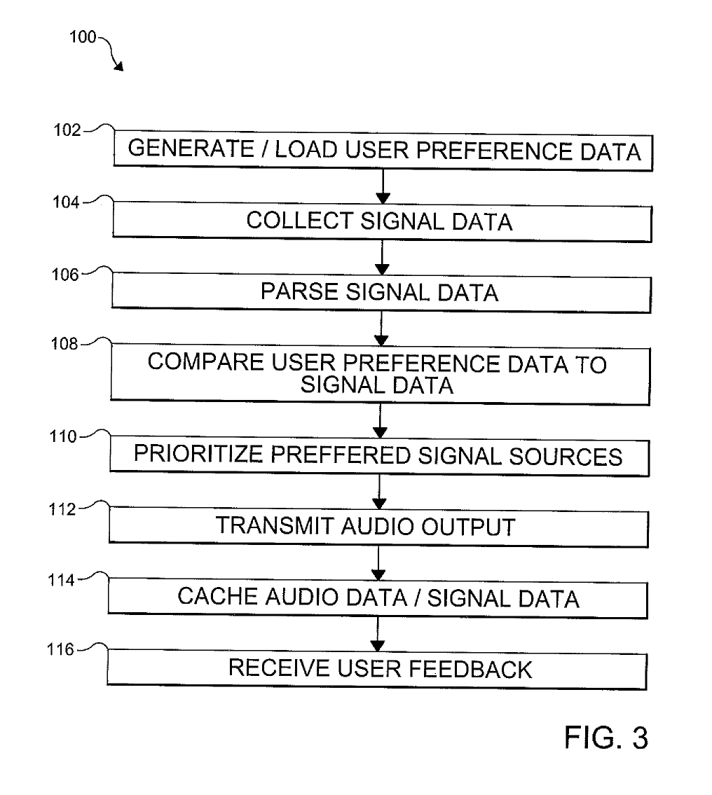

FIG. 3 illustrates a method 100 for adapting an audio output using both terrestrial and internet radio signal sources 28, 36. In step 102, the user preference data 24 is provided (e.g. generated based on a user-provided input, received from a device, downloaded from the Internet 22, retrieved from the storage device 42, etc.).

In step 104, at least one of the first tuner 14 and the second tuner 16 scans a pre-determined spectrum of broadcast signals and receives a plurality of the terrestrial radio signals 34 associated with various signal sources 36. It is understood that one of the tuners 14, 16 can be configured to scan the broadcast spectrum to collect the signal data 38 associated with various ones of the signal sources 36, while the other of the tuners 14, 16 is configured to selectively tune to one of the signal sources 36 to selectively provide an audio output to the user.

Certain ones of the terrestrial radio signals 34 received by at least one of the tuners 14, 16 do not include information relating the audio attributes of the signal source 36. Accordingly, the processor 18 can analyze the terrestrial radio signals 34 to extract information about the audio output and generate information about the signal source 36 of the terrestrial radio signal 34 based upon the audio output, as appreciated by one skilled in the art.

In step 106, the processor 18 receives at least one of the internet radio signals 26 and the terrestrial radio signals 34 including the respective signal data 30, 38. As a non-limiting example, the processor 18 parses the signal data 30, 38 into data fields for subsequent comparison.

In step 108, the processor 18 receives the user preference data 24 from at least one of the communication device 12 and the user interface 20 and analyzes the user preference data 24 based on the instruction set 40. For example, the processor 18 compares the user preference data 24 to the signal data 30, 38 of at least one of the internet radio signals 26 and the terrestrial radio signals 34 to determine which of the signal data 30, 38 substantially matches the user preference data 24. It is understood that the processor 18 can designate a particular signal source 28, 36 as a “preferred” source or channel. It is further understood that any number of the signal sources 28, 36 can be designated as a “preferred” channel.

In step 110, the processor 18 generates a priority list of the “preferred” ones of the signal sources 28, 36 (e.g. terrestrial radio channels and internet radio channels) in response to the comparison executed in step 108. In certain embodiments, the priority list is arranged based upon a signal strength of the preferred ones of the signal sources 28, 36. For example, the processor 18 detects a signal quality of each of the terrestrial radio signals 34 and the Internet radio signals 26 and prioritizes the preferred signal sources 28, 36 based upon signal strength.

In certain embodiments, the priority list is arranged based upon genre of music. For example, the user can identify a specific genre or style of music and the processor 18 prioritizes the preferred ones of the signal sources 28, 36 based upon a level of relevance with regard to the specific genre of music identified by the user.

In certain embodiments, the priority list is arranged based upon a navigation route or global position of the vehicle 21. For example, the processor 18 detects a navigation route of the vehicle 21 and prioritizes the preferred ones of the signal sources 28, 36 based upon a position of the vehicle 21 along the navigation route. It is understood that any metric or priority classifier can be used to organize or prioritize the preferred ones of the signal sources 28, 36.

In step 112, the processor 18 transmits an audio output to the user. As a non-limiting example, the processor 18 selects one of the preferred signal sources 28, 36 as the source of the audio output. As a further non-limiting example, the processor 18 can select any source for the audio output such as the portable electronic device 54, for example.

In step 114, the processor 18 caches a pre-determined amount of data representing an audio output. As a non-limiting example, a digital audio data (e.g. audio data 56) can be stored locally on the storage device 42 for immediate playback as the audio output. As a further non-limiting example, a stream of the signal data 30, 38 can be received and stored locally on the storage device 42 for subsequent playback. Accordingly, the radio system 10 can provide seamless playback of the audio output without interruption during processing or searching for viable signal sources 28, 36.

In step 116, the user can interact with the user interface 20 in order to provide a feedback. As a non-limiting example, the user engages one of the buttons 50 representing a particular one of the priority classifiers 52 to prioritize a list of the “preferred” ones of the signal sources 28, 36. As a further non-limiting example, the user engages one of the buttons 50 representing a “like” feedback. Accordingly, the signal data 30, 38 associated with the audio output currently being transmitted to the user is used to update the user preference data 24.

In another method, a first user member can interact with at least a second user member in a designated closed group of user members for communicating with user members information related to a transmitted audio output in step 112. Via connectivity such as, but not limited to, Internet, Wi-Fi, or smart phone, the radio system 10 of the first user member is informed of the current song playing on a radio system 10 of at least a second user member of the closed group. This shared information allows the radio system 10 of the first user member to know what other user members in the closed group are playing. The radio system 10 of the first user member may use this information as an input to the content selection of the first user member in addition to the first user member's source of terrestrial broadcast radio and Internet data signal. In one embodiment, if many user members in the closed group are listening to a particular song at a particular time from a source, for instance a terrestrial broadcast radio, this song may be of interest to the first user member in the closed group who is not listening to this particular song at the particular time, for instance, the first user member may not have turned on the radio system 10. The first user member's radio system 10 is informed of the preference for this particular song by the multiple user members of the closed group. This information can be used by the first user member's radio system 10 to guide song selection in the future by updating the database 44 of the first user member. In another embodiment, the radio system 10 of the first user member may automatically switch to the source playing the particular song at the time the radio system 10 is informed of the particular song of the closed group.

In another embodiment, a first user member may access the database 44 of at least a second user member of the closed group by engaging one of the buttons 50 representing the second user member's database 44. Accessing the database 44 of the second user member allows the radio system 10 of the first user member to use the second user member's database 44 for future song selection and play. The database 44 for each user member within the closed group benefits every member of the closed group, especially where the data is not currently available to every user member.

In another method, a user member of the closed group described above may be informed of a communication such as an interesting event via audio from a broadcast or connectivity, or data from connectivity. Via connectivity, the user member informs others in the group and the group connectivity is informative. If the communication is received via an audio announcement, the user may record the communication information and send the recording to other members of the closed group. Similarly, if the communication is received via text, the user may forward the text information to other members of the closed group. Alternatively, the group connectivity is interactive. In the case of audio, a user member may use their system to record all or part of the audio event announcement, and the system can send this recording to the group. In certain embodiments, all group members can interact by sending a text or a voice recording to the group, such as, “I will go to it. Do you want to go?” Each user member of the group may interact by pressing preset buttons 50 indicating particular phrases, symbols, characters or text responses such as “I will go” or a “thumbs up” symbol. These preset responses are set by a user via the user interface 20. The user interface 20 may provide a keypad to type in individually established responses. Via connectivity, other entities, such as a second closed group, may be informed of this interaction for various purposes. For example, a closed group may provide information about the closed group to third parties, such as informing a concert promoter of a closed group having a common interest in certain types of music and artists. The concert promoter can send a message via connectivity to the closed group about attending a relevant event, and so inform the closed group that they can receive a ticket discount for the closed group. The concert promoter may inform the closed group of a relevant event by other means of communication such as Internet stream, radio announcement for the closed group, or by a streaming commercial, for instance.

In certain embodiments, the radio system 10 may allow song ratings from multiple users in a closed group. The radio system 10 aggregates these song ratings to create a new profile for the closed group. Each user member of the closed group can use the aggregate profile as their own, supplementing or replacing the profile of the user member's radio system 10. Additionally, user members of the closed group may provide user feedback to the closed group about the content of the aggregate profile. A user member may indicate a “like” or “dislike” through the user interface 20 to the closed group. Additionally, each user member of the group may interact with other user members of the group about the content of the aggregate profile automatically when indicating a “like” or “dislike” or by pressing preset buttons 50 indicating particular phrases, symbols, characters or text messaging. User members of the closed group may use this user feedback 116 to control selection of subsequent sources and songs for playing. This method is advantageous for a closed group traveling on trip together, or for a closed group that travels together periodically, such as a business team, for example. In certain embodiments, the closed group may be travelling in a caravan, with the system sharing sources, preferences and all playing the same song at the same time. Related content, such as graphics, can also be shared. Similarly, if a user member has rated a song as a favorite, the rating may automatically be shared with other user members. Alternatively, the user member presses a button 50 to make it a recommended song. Via connectivity, the user member's closed group of friends is automatically informed of the recommendation. The closed group aggregate profile may be available to a user member at any time. In one example, a user member may purchase a new vehicle. The new vehicle will not include the user member profile or a group aggregate profile. The user member can set the radio system 10 to include the group aggregate profile, advantageously providing the user member access to the group's database 44.

The radio system 10 according to the present invention selectively transmits an audio output from one of a plurality of sources (e.g. signal sources 28, 36, portable electronic device 54) to a user based upon a preference of the user. Accordingly, the radio system 10 provides a comprehensive solution to preference-based audio playback in various environments including a moving vehicle.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A method for connecting users to a transmitted audio output, the method comprising:
providing at least two communication devices for receiving an audio output;
providing user preference data including defining a first user and at least a second user forming a group of users;
connecting the group of users for communicating between the at least two communication devices; and
selectively sharing information from at least one user of the group of users to at least the second user of the group.

2. The method according to claim 1, wherein the selectively shared information is at least one of audio and text.

3. The method according to claim 2, further comprising the step of:
informing the least one user of the group of the transmitted audio output of at least the second user of the group.

4. The method according to claim 2, further comprising the step of:
at least one user of the group of users selecting a transmitted audio output from sources including at least one of a terrestrial broadcast radio signal, an Internet data signals, and the audio output of at least a second user of the group.

5. The method according to claim 4, further comprising the step of:
at least one user of the group of users transmitting text to the at least second user of the group.

6. A method for connecting users to a transmitted audio output, the method comprising:
providing at least two communication devices for receiving an audio output;
providing user preference data including defining at least two users forming a group of users, wherein the group of users forms a closed group;
connecting the closed group for communicating between the at least two communication devices; and
selectively transmitting an output from at least one user to the closed group by the connection.

7. The method according to claim 6, wherein the user preference data of the at least two users comprises at least two databases.

8. The method according to claim 7, further comprising the step of aggregating the at least two databases to form a closed group database.

9. The method according to claim 6, wherein the output selectively transmitted is at least one of audio and text.

10. The method according to claim 7, further comprising the step of informing the at least one user of the closed group of the database of at least a second user of the closed group.

11. The method according to claim 8, further comprising the step of at least one user of the closed group selecting a transmitted audio output from sources including at least one of a terrestrial broadcast radio signal, an internet data signal, and the closed group database for audio transmission and listening by the at least one user.

12. The method according to claim 8, further comprising the step of at least one user of the closed group selecting a transmitted audio output from sources including at least one of a terrestrial broadcast radio signal, an internet data signal, and the closed group database for audio transmission and listening by the closed group.

13. The method according to claim 9, further comprising the step of:
at least one user of the group of users transmitting text to the at least second user of the group.

14. The method according to claim 9, further comprising the step of:
at least one user of the group of users transmitting text to the closed group.

15. The method according to claim 14, wherein output to the closed group further comprises the step of:
informing a nonmember entity of the closed group including at least one user member preferences.

16. The method according to claim 15, and further comprising the step of the nonmember entity communicating information to the closed group, wherein the information is based on the at least one user member preferences.

17. A method for connecting users to a transmitted audio output, the method comprising:
providing at least two communication devices for receiving an audio output;
providing user preference data including defining a first user and at least a second user forming a group of users, wherein the group of users forms a first closed group;
connecting the first closed group of users for communicating between the at least two communication devices;
selectively transmitting an output from at least one user of the first closed group to at least the second user of the first closed group;
providing a second closed group;
providing the second closed group at least one communication device for receiving an audio output; and
the first closed group providing access to the transmitted audio output of the first closed group to the second closed group.

18. The method of claim 17, further comprising the step of the second closed group communicating with the first closed group.
